(19) United States
(12) Patent Application Publication
(10) Pub. No.: US 2005/0181183 A1
(43) Pub. Date: Aug. 18, 2005

(54) Application of images to surfaces

(76) Inventor: Barry David Pacey, Monmouthshire (GB)

Correspondence Address: Edwin D Schindler, Five Hirsch Avenue, PO Box 966, Coram, NY, 11727-0966, US

(21) Appl. No.: 10/481,117

(22) PCT Filed: Jun. 13, 2002
(86) PCT No.: PCT/GB02/02459

(30) Foreign Application Priority Data
Jun. 15, 2001 (GB) 0114530.9

(51) Int. Cl. B32B 7/00

(52) U.S. Cl. 428/195.1; 156/71; 428/343

(57) ABSTRACT

A layered structure for providing an image on a desired surface includes a reinforcing substrate layer carrying an image, an optional protective transparent coating over the image and a material with adhesive properties for adhering the reinforcing substrate layer to the desired surface. The material with adhesive properties may be an adhesive, such as a bituminous adhesive, a thermoplastic material or a curable composition.

The present invention relates to image structures applied temporarily or semi-permanently or permanently to surfaces, and to methods of applying the images to surfaces. The invention relates in particular to the application of image structures to road surfaces, car park surfaces and hard-standing surfaces such as concrete or tarmac and to other surfaces such as playgrounds, corridors, footpaths, walls, ceilings and columns. The invention is especially suitable for surfaces subject to high degrees of wear and tear from vehicles and foot traffic. A particular advantage of the applied image structures of the invention is that the image structures are removable without significant damage to the underlying substrate. This allows the image structure to be removed and replaced by a new image as and when required.

The applied image structures according to the invention are useful in providing information and instructions to vehicle drivers and pedestrians, in the form of road markings or markings applied to car park surfaces as well as for advertising use. The removability of the image structures further allows their use as advertising media, logos and emblems applied, for example, to car park, road or footway surfaces and where the image structure can be replaced with a new image structure at appropriate time intervals such as after a number of weeks or months. The image structures according to the invention are durable in use, for example, to resist abrasion from foot traffic and vehicle wheels and can provide anti-slip and anti-skid surfaces.

Conventional road markings are produced from special paints and thermoplastic materials. For example, the image may be produced by cutting out a sheet of thermoplastic material to form the required wording or logo and the resulting cut-out is then fixed to the road surface. The thermoplastic materials are normally heated before application and require specialised application equipment. The quality of the resulting images is generally poor, and only relatively simple, low definition images can be achieved. The conventional markings also require specialised equipment for their removal, are difficult to remove completely and usually the act of removing the markings leaves some damage to the underlying surface.

The present invention seeks to overcome the disadvantages by providing image structures carrying high quality, high definition images which, while remaining securely in place for their intended period of use, are easily removable without significant damage to underlying surfaces. It is noted that, for example, the surfaces of car parks may be treated, for example, with particular anti-slip or oil-resistant compositions and the image structures of the invention—appropriately applied—are removable without significant damage to such surfaces.

In accordance with the invention, the above-mentioned disadvantages are overcome by providing a reinforcing substrate layer, preferably of a reticulate material such as a mesh material, especially a mesh fabric material, which can carry a high quality image (preferably a printed image), such as an instruction, a warning or advisory sign, an advertising message or sponsor's logo. The image is most preferably printed directly onto the reinforcing substrate layer, although the image may be printed onto an additional layer or substrate which is then attached to the reinforcing substrate layer. Means are then provided for attaching the reinforcing substrate layer to the desired surface, as discussed below. The reinforcing layer imparts sufficient strength to the image structure of the invention so that the structure is not distorted, ruptured, displaced or otherwise degraded by lateral forces such as those exerted by a vehicle tyre when the vehicle is turning or braking heavily. The strength imparted by the reinforcing layer is also important in easing the removal of the image structure from the surface, desirably in a single piece. In preferred variations, a further mesh layer is disposed between the means for attaching the reinforcing layer and the surface. In this way, removal of the image structure when desired is further facilitated.

According to a first aspect of the present invention, there is provided a layered structure for providing an image on a desired surface comprising:
(i) a reinforcing substrate layer
(ii) an image applied to an upper surface of the reinforcing layer
(iii) a layer comprising a material with adhesive properties for adhering the lower surface of the reinforcing layer to the said desired surface.

In a most preferred embodiment of this aspect of the invention, a further mesh layer is disposed on the face of the layer comprising a material with adhesive properties distal from the reinforcing layer. That is, the further mesh layer is disposed in use between the material with adhesive properties and the surface to which the image structure is attached.

Preferably, a protective transparent coating is applied over and, especially, around the marginal edges of the image. Preferably also the protective transparent coating includes small particles of anti-slip aggregates, such as one or more materials selected from glass beads, clear silica beads and opalescent sand.

It is especially preferred that the image is a printed image and more especially it is preferred that the image is printed directly onto the reinforcing substrate layer. Alternatively, the image may be printed onto a substrate, which substrate is applied to the reinforcing substrate layer. In this specification, “printing” includes sublimation techniques in which a negative image is provided on an initial substrate which is first juxtaposed with the reinforcing substrate layer (or substrate attached, or to be attached, to the reinforcing substrate layer) and then heated, causing the ink or other material forming the image to sublime and diffuse into, or otherwise penetrate, the reinforcing substrate layer (or substrate), so that the image is transferred to the reinforcing substrate layer (or substrate).

In the most preferred variations of the invention, the reinforcing substrate layer comprises a reticulate material and in particular a web of mesh material such as a mesh fabric. In preferred constructions the mesh material, in addition to providing the necessary strength to the structure may also allow the material with adhesive properties to permeate into the mesh. This (in conjunction with the optional coating layer, which may be of the same material) allows the image to be completely encapsulated thereby providing improved resistance to degradation resulting from—for example—adverse weather, such as by moisture ingress. Further, permeation of the material with adhesive properties into the reinforcing substrate layer assists in resisting relative displacement of the layers of the image structure which might otherwise result from the forces exerted by vehicle wheels when turning or braking.

In a first preferred embodiment of this aspect of the invention the layer of material with adhesive properties is an adhesive, especially a pressure sensitive adhesive.

A particularly preferred layer of material with adhesive properties in accordance with this first embodiment comprises a bituminous adhesive layer, more especially a glass fibre reinforced bituminous adhesive layer.

In a second preferred embodiment of this aspect of the invention, the layer of material with adhesive properties comprises a high-tack thermoplastic material.

In a third preferred embodiment of this aspect of the invention, the layer of material with adhesive properties comprises a liquid composition which is cured at the site of application.

In a fourth preferred embodiment of this aspect of the invention, the layer of material with adhesive properties comprises a rubberised material, optionally in conjunction with a layer of adhesive on the rubberised material.

A particular advantage of the above third embodiment of the invention derives from the curing time of the curable composition. Thus, the curing time allows the location of the image structure to be adjusted after it has been applied to the desired surface, This facility is especially useful when a final image of, for example, large area is made up from a number of individual image structures. The relative locations of the individual image structures can thus be adjusted before the curing is complete.

According to a second aspect of the present invention, there is provided a method of applying an image structure to a desired surface comprising the steps of:
(a) providing a layered image structure comprising
   (i) a reinforcing substrate layer
   (ii) an image applied to an upper surface of the reinforcing layer, and
   (iii) a layer comprising a material with adhesive properties applied to the lower surface of the reinforcing layer;
(b) optionally pre-treating the layer comprising the material with adhesive properties (preferably by heating the said layer) to make it adherent; and
(c) applying the layered image structure to the desired surface.

In a particularly preferred embodiment, the layered image structure may further comprise
(iv) a further mesh layer disposed on the face of the layer comprising the material with adhesive properties distal from the reinforcing layer. That is, the further mesh layer is, in use, disposed between the material with adhesive properties and the surface to which the image structure is attached.

In one embodiment of this aspect of the invention the layer of material with adhesive properties is an adhesive, especially a pressure sensitive adhesive.

A particularly preferred layer of material with adhesive properties in accordance with this embodiment comprises a bituminous adhesive layer, more especially a glass fibre reinforced bituminous adhesive layer.

In another embodiment of this aspect of the invention the layer of material with adhesive properties comprises a high-tack thermoplastic material. In an alternative embodiment the layer of material with adhesive properties comprises a rubberised material, optionally in conjunction with a layer of adhesive on the rubberised material.

According to a third aspect of the present invention there is provided a method of applying an image structure to a desired surface comprising the steps of:
(a) providing a layered image structure comprising
   (i) a reinforcing substrate layer, and
   (ii) an image applied to an upper surface of the reinforcing layer,
(b) applying a layer comprising a material with adhesive properties to the desired surface; and
(c) applying the layered image structure to the adhesive material.

In a particularly preferred embodiment, the layer comprising a material with adhesive properties may further include a further mesh layer disposed on the face of the layer comprising the material with adhesive properties distal from the reinforcing layer. That is, the further mesh layer is, in use, disposed between the material with adhesive properties and the surface to which the image structure is attached.

In a variation of the above preferred embodiment, the same result may be achieved by varying step (b) above. In this variation, step (b) comprises
(b)(i) applying a further mesh layer to the desired surface, and
(b)(ii) applying the layer comprising a material with adhesive properties over the further mesh layer to the desired surface.

Preferably in one embodiment of this aspect of the invention the layer comprising a material with adhesive properties comprises a high-tack thermoplastic material. In other embodiments the layer comprising a material with adhesive properties may be an adhesive layer or a layer of rubberised material, is defined in relation to the second aspect of the invention.

In another preferred embodiment of this aspect of the invention the layer comprising a material with adhesive properties comprises a material which is cured at the site of application.

In the second and third aspects of the invention, it is most preferred that the image comprises a printed image, and further that the reinforcing substrate layer comprises a reticulate material, in particular a mesh material such as a mesh fabric.

Most preferably the methods of the second and third aspects of the invention further include the step of applying a protective transparent coating over the image.

According to a fourth aspect of the present invention, there is provided a system for applying an image to a desired surface comprising:
(a) a layered image structure comprising
   (i) a reinforcing substrate layer, and
   (ii) an image applied to a surface of the reinforcing layer, and
(b) a quantity of adhesive material, for application to the reinforcing substrate layer and/or the desired surface, sufficient for adhering the reinforcing substrate layer to the surface.

Preferably, the system flirter comprises
(c) a further mesh layer, for disposal in use between the adhesive material and the surface.

Preferably in this fourth aspect of the invention, the image is a printed image. Preferably also the reinforcing substrate layer comprises a reticulate material, especially a mesh material such as a mesh fabric.

In another preferred variation of this aspect of the invention, the layered structure further comprises a protective transparent coating applied to the image.

In a preferred embodiment of this fourth aspect of the invention, the adhesive material is in the form of a curable composition. Most preferably the adhesive material is a two component system and the components are mixed to initiate curing.

Thus, in its various embodiments, the present invention provides three means by which the reinforcing substrate layer carrying the image can be attached to the desired surface.

In a first embodiment, an adhesive such as a bituminous adhesive or a pressure sensitive adhesive, especially a glass fibre reinforced bituminous adhesive, is used to attach the underside of the reinforcing substrate layer to the surface. Where a pressure sensitive adhesive is used, pressure may be applied to the image structure—such as by a heavy roller—in order to achieve adhesion to the surface. Preferably, the adhesive is applied to the underside of the reinforcing substrate layer during production. The bituminous adhesive may include bitumen or bitumen-like materials. The adhesive may be activated at the site of application of the image structure, such as by warming to soften the adhesive, and the layered structure comprising the reinforcing substrate layer carrying the image and the adhesive layer is then applied to the surface. In other variations, the adhesive is inherently tacky and does not require activation Preparation of the surface to remove loose materials will normally be required and application of a conventional primer may be desirable in some circumstances, for example if the surface is friable. The particular formulation of the adhesive will depend on the particular conditions of use, such as the amount and nature of foot or vehicle traffic passing over the image structure and the ambient temperatures. For example, installation in warmer climates or environments will require adhesives which are more resistant to thermally induced softening than will installation in colder climates. In car parks, the nature of the adhesive must be such as to prevent the image structure from becoming dislodged, slipping or creeping when subjected to the stresses imposed by vehicle wheels when the vehicle is turning sharply. Installation on public roads requires the adhesive to resist displacement of the image structure caused by high vehicle speeds and rapid acceleration or braking.

Suitable bituminous adhesives include rubber modified bitumens and tackyfied bitumen compounds. Suitable non-bituminous adhesives include water based adhesives, solvent based adhesives and hot melt adhesives.

Optionally, but most desirably, the outer surface of the image structure carried on the reinforcing substrate is provided with a transparent protective coating. The protective coating may act to enhance the image but serves primarily to protect the image structure from degradation by environmental factors such as rain water or u.v. light. To improve its durability and resistance to the abrasive action of, for example, vehicle wheels, additional layers of the protective coating may be applied. To provide the protective coating with anti-slip or anti-skid properties the protective coating may include particulate materials such as glass beads, clear silica beads and opalescent &and. The particulate materials may simply be added to the surface of the protective coating directly after its application, before it has dried or cured. Suitable protective coating materials include polyurethanes such as water-based two pack polyurethanes, two-pack acrylic modified polyurethanes and single pack moisture cured polyurethanes.

In the second and third embodiments, the material serving to adhere the reinforcing substrate layer to the surface is preferably applied separately at the site of application of the layered image structure to the surface. An initial layered image structure is manufactured comprising the reinforcing substrate layer carrying the image and, optionally, the protective coating. This layered structure is then adhered to the desired surface.

In the second embodiment, a thermoplastic material is preferably applied first to the desired surface. A heat source such as a heat gun may be used to ensure that the thermoplastic material becomes sufficiently tacky. Preferably, the thermoplastic material is formulated to become sufficiently tacky at a temperature lower than the above-described conventional thermoplastic materials. Ideally, the adhering surfaces of the thermoplastic material are heated to a temperature of about 90° C. to 130° C.

The layered image structure is then laid on top of the thermoplastic material and pressed firmly down in order to secure the lay image structure to the surface. However, it is possible to provide the thermoplastic material as a part of the whole image structure which is then applied as a whole to the surface, in the manner of the first embodiment.

On some surfaces, it may be desirable to apply a primer to the surface before the thermoplastic material is applied in order to improve the adhesion of the thermoplastic base layer to the surface. Suitable thermoplastic materials will often include in addition to the polymer, one or more of mineral oils, extenders, aggregates and other polymer additives, in order to achieve desired properties, as is known in the art. Ideally, the thermoplastic material will achieve the desired tackiness at a temperature of about 150° C. and will be applied in a thickness of about 0.5 mm to 5 mm, preferably 1 mm to 2 mm.

Again, the choice of the particular thermoplastic material which is used will depend on the environment (e.g. ambient temperature and moisture levels) and location (road or car park or wall etc.). Thermoplastic materials which are especially useful for adhering the image structure to road and car park surfaces include those which enable the layered image structure of the invention to comply with the relevant requirements of standard numbers BS EN 1436, BS EN 1871 and BS EN 1824.

In the third embodiment, a curable composition in liquid form, such as an acrylic composition or a polyurethane composition is used to adhere the initial layered image structure to the substrate. The curable composition is applied in liquid form to the desired surface and is spread evenly over the surface. The layered image structure is then pressed firmly down onto the curable material, so that it is retained in place. Materials which cure rapidly are preferred, with a cure time of about 10 minutes to half an hour, depending on environmental conditions. This curing time allows precise adjustment of the location of the image structure before curing is completed and the final position is fixed.

Curing may be achieved by a polymerisation reaction or a cross-linking reaction. Desirably, the curable material may be supplied as two precursors in two separate packs. The precursors are mixed immediately before use to initiate curing. For example, one pack may include a cross-linkable polymer and the second pack may include an initiator for the cross-linking reaction. In another example, one pack may include a first co-monomer and the second pack may include a second co-monomer and an initiator for the polymerisation reaction of the co-monomers. Alternatively, both co-monomers may be contained in the same pack, with the initiator in a second pack. In further embodiments, the curable material may be curable by exposure to the atmosphere, or may be thermally or u.v. curable.

A particular advantage or the liquid curable materials is that they can also serve to level minor imperfections in the surface to which the image is applied, thereby enhancing the quality of the image. Also, because the curing reaction is not reversible, the cured composition is less susceptible to changes due to environmental factors as compared with adhesives such as bituminous adhesives or thermoplastic materials. For example, increases in ambient temperature will not lead to significant softening of the cured material, which softening could allow creeping or slippage of the image on the surface.

Particular examples of suitable curable materials include blends of polyether polyols which react in the presence of a catalyst to form clear polyurethane elastomers, and, two-part acrylic resins, with fillers.

In a particularly preferred variation of the first, second and third embodiments described above, the material with adhesive properties may be selected to be generally the same material as the protective coating. In this way, full encapsulation of the image—as discussed above—may be achieved. Polyurethanes are especially suitable in this case. Thus, a lower body of a polyurethane (or other material with adhesive properties) serves to adhere the reinforcing substrate layer carrying the image to the desired surface, and an upper body of a polyurethane (or other suitable coating material) serves as a protective coating. The lower (and possibly the upper) body of polyurethane may become absorbed into the material of the reinforcing substrate layer so that the image and the reinforcing substrate layer become completely encapsulated so that the image is protected especially well from degradation by environmental or other factors. Of course, it is not essential to this variation of the invention that the upper body of the protective coating and the lower body of the material with adhesive properties are the same material, provided that the respective materials co-operate to provide the desired encapsulation. Such encapsulation may, however, be more easily achieved when the materials are generally the same.

In each of the above three embodiments of the invention, the image structure is preferably provided with a layer of a further reticulate or mesh layer which is disposed in use between the layer of material with adhesive properties and the surface to which the image structure is applied. This may be achieved in one of two ways, as appropriate. Either, the further mesh layer may be formed as a part of the image structure which is applied as a whole to the surface, or, the further mesh layer may be applied separately to the surface in an initial step, with the remainder of the image structure components applied over the mesh layer. In particular, in the first embodiment where the layer of material with adhesive properties comprises an adhesive such as a bituminous adhesive, the further mesh layer is most preferably applied to the lower face of the adhesive (i.e. the face which adheres to the desired surface in use). The whole image structure including the further mesh layer may then be applied to the desired surface. The further mesh layer and the adhesive face may initially be covered by a release paper or film which is peeled away before application of the image structure to the surface.

In the second embodiment, the further mesh layer is preferably applied to the desired surface (after any required primers) and the thermoplastic material is applied to the further mesh layer so that it adheres to the surface through the mesh layer. The remainder of the image structure is then applied to the thermoplastic material as described above.

In the third embodiment, the further mesh layer is applied in generally the same manner as is preferred for the second embodiment. That is, the further mesh layer is applied first to the desired surface (after any primer if required) and the curable composition is applied to the further mesh layer to adhere to the desired surface through the mesh layer. The remainder of the image structure is then applied to the curable composition as described above.

The further mesh layer is advantageous in helping to ensure that the image structure can be removed from the surface when desired. The further mesh layer helps to ensure that the image structure maintains its integrity on removal (i.e. remains as a single piece) without breaking up unduly and also to minimise any residue which might otherwise be left on the surface after removal of the image structure. Also, while the image structure is in place on the surface, the further mesh layer can help to minimise or eliminate “creep” (i.e. gradual movement) of the image structure due to the action of vehicles or pedestrians passing over the image structure. Such creep could potentially occur if, for example, ambient temperatures are sufficiently high as to soften the layer of material with adhesive properties. Similarly, the further mesh layer can restrict or eliminate any flow of the layer of material with adhesive properties which might occur under the pressure of a vehicle passing over the image structure if the material has become softened. If such flow is not restricted by the further mesh layer (and assuming ambient conditions are sufficiently severe to permit such flow), the layer of material with adhesive properties could potentially become unevenly distributed beneath the reinforcing substrate layer so that the adherence of the image structure to the surface could be compromised aid, in the worst case, amounts of the material with adhesive properties could be “squeezed” out of the edges of the image structure.

The mesh size of the further mesh layer will typically be larger than that of the mesh fabric which may be used for the reinforcing layer. Typically, the further mesh layer will have a mesh size of about 2 mm to about 10 mm, preferably about 4 mm to about 6 mm and will typically comprise an open weave of synthetic fibres or yarn, such as polyester or polypropylene fibres.

For a better understanding of the invention and to show how the same may be carried into effect, reference will be made to attached drawings in which:

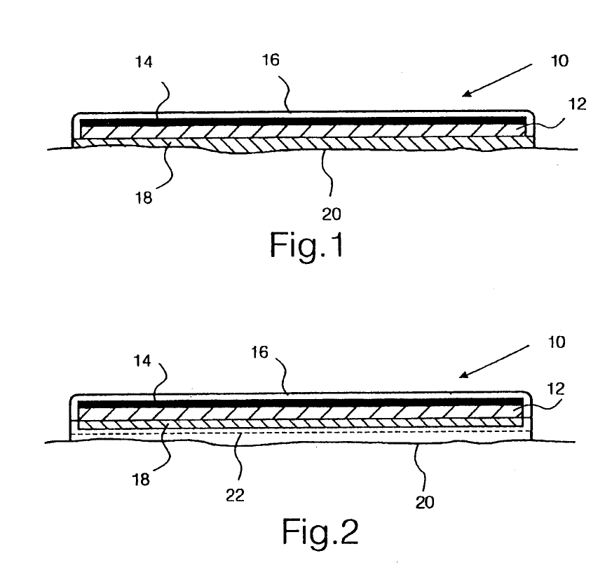

FIG. 1 which is a schematic sectional view of a layered image structure according to the invention; and

FIG. 2 is similar to FIG. 1 showing in addition the further mesh layer.

In FIG. 1, the layered image structure of the invention, indicated generally as 10; is shown adhered to a surface 20. The layered image structure 10 comprises a reinforcing substrate layer 12 which is preferably a mesh material layer of natural or synthetic materials which may be woven and which may include, or may be, a paper layer. Suitable materials for the mesh fabric layer include synthetic materials such as polyester fabrics including polyester/PVC blends and polyester/cotton blends of which pre-treated (chemically etched) PVC/polyester mesh suitable for digital printing is most preferred. A mesh size of about 0.5 mm to about 2 mm or a pore density (i.e. the number of holes in the mesh per unit area) of about 10/cm² to about 90/cm²is typical, in order to provide an adequate surface on which the image can be printed while meeting the conflicting desire for some of the material of the layer of the material with adhesive properties 18 to penetrate the mesh. Such penetration assists in adhering the mesh material 12 to the layer 18 of material with adhesive properties and also helps in the encapsulation of the image to prevent damage from the environment (e.g. water penetration). As will be explained below, in addition to providing required in-use strength, the reinforcing substrate layer serves to facilitate the removal of the layered image structure from the surface when desired. As such, desirable properties of the reinforcing substrate layer include a density of about 550 g/m², a typical strength of about 1500N/mm and u.v. stability The reinforcing substrate layer will also desirably have fire retardant properties complying with DIN 75200 and BS 5438 2A and 2B. The strength (and other properties) of the reinforcing substrate layer will depend on the material chosen for this layer. The choice is determined in accordance with the intended use or location of use of the image structure and also depends on the materials of the other constituent layers of the image structure. The strength and other properties required to prevent damage to or degradation of the image structure by external (e.g. vehicle generated) forces can be determined in the light of the present disclosure by simple experiment by a person skilled in the art.

An image 14 is applied, preferably directly, to the reinforcing substrate layer 12. It is especially preferred that the image 14 is printed onto the reinforcing substrate layer 12. Printing enables the production of high quality, coloured and high definition images in multiple copies and it is particularly preferred that the image is a digital image. In alternative constructions, the image may be applied to a separate substrate (e.g. of relatively low strength) which is, in turn, adhered or otherwise attached to the reinforcing substrate layer. Such a substrate may be a reinforced paper/polypropylene film construction. Techniques for printing images onto a wide range of materials are well known in the printing art and need not be described further.

A protective coating layer 16 which is preferably transparent, may be applied over the image. The protective layer 16 is desirable in order to protect the image from wear due to contact with vehicle and foot traffic and to protect the image from environmental factors such as water (ambient moisture, rain, water run-off from adjacent surfaces etc.) and radiation such as u.v. radiation. The protective coating can also serve to provide desired physical properties to the outer surface of the layered image structure, such as skid or slip resistance. The protective coating 16 may be applied over the image 14 during manufacture of the layered image structure, or may be applied on site after application of the layered image structure to the surface 20. Suitable materials for the protective coating 16 include polyurethanes and modified polyurethanes as described above.

The layered image structure is attached to the desired surface 20 by means of a material 18 with adhesive properties, as discussed below.

A typical image structure according to the invention will have a thickness in the range of from 2 to 10 mm, preferably 2 to 5 mm and especially about 3 mm. The image structure can achieve a puncture resistance at least 300N and more especially at least 400N. A mean skid resistance of an image structure according to the invention has been tested in accordance with British Standard BS3262: 1989 and values in excess of 65 have been achieved.

In the first embodiment of the invention, the material 18 is an adhesive such as a pressure sensitive adhesive and especially a bituminous adhesive which may be applied to the underside of the reinforcing substrate layer 12 during production and may become absorbed to a limited extent in the reinforcing substrate layer. Rubberised materials are also suitable. For application of the layered image structure 10 to the surface 20, the adhesive material 18 is preferably heated by suitable means such as a hot air gun to make it tacky. Other suitable materials may be inherently tacky so that no heating is required. Such materials are desirably covered by a release paper or film which may be peeled off when desired. The layered image structure 10 is then applied to the prepared surface 20 and pressed firmly down (such as by a heavy roller) to ensure that a good adhesive bond is formed with the surface 20. A primer layer may be applied to the surface 20 before the layered image structure 10 is applied, in order to improve the adhesive bond In an alternative form of this first embodiment, the adhesive, especially a bituminous adhesive, may be formed as a separate layer or substrate which is applied directly to the spice 20, following which the layered image structure 10 comprising the reinforcing substrate layer 12, the image 14 and optionally the protective coating 16 is applied to the adhesive layer 18 and pressed firmly down. Again, the adhesive layer 18 may be heated if necessary before application to the surface 20 and/or before application of the layered image structure 10. Again, the protective coating 16 may be applied after the application of the layered image structure 10 to the surface 20. It is, however, preferred that the adhesive layer is formed integrally with the remainder of the image structure.

In the second embodiment of the invention, the material 18 represents a thermoplastic material, preferably in sheet form. The thermoplastic material is selected to have a high tack surface which, before the layered image structure is laid onto the surface 20, may require activation such as by a heat source. Generally heating to a surface temperature of about 90° C. to 100° C. is desirable, which may be achieved by means of a hot air gun, propane gas torch, infra-red radiant heater, or the like. Thus, the application of heat or other activation provides or enhances the tack of the thermoplastic material. The pre-formed layered image structure comprising the reinforcing substrate layer 12, the image 14 and optionally the protective coating 16 are then applied to the thermoplastic material layer 18 and pressed down firmly to ensure a good bond. A primer may be applied to the surface 20 before application of the thermoplastic material 18. Again, the optional protective coating 16 may alternatively be applied after the application of the layered image structure 10 to the surface 20.

In the third embodiment of the invention, the material 18 comprises curable composition in liquid or paste form which is applied to the surface 20. Again, a suitable primer may be applied first. The curable composition preferably cures in a relatively short time, for example, less than about half an hour, more especially in about ten minutes. This rapid curing facilitates the rapid application of a number of layered image structures 10 to surfaces 20 by a worker or workers. The curing time allows final adjustment of the position of the image structure which is especially useful where a number of adjacent image structures are applied to form a final (large) image. The layered image stricture 10 comprising the reinforcing substrate layer 12, the image 14 and optionally the protective coating 16 is applied to the curable composition 18 as soon as possible after the curable composition 18 has been applied to the surface 20, and certainly before the curing is complete. Following curing of the composition 18 the layered image structure 10 is firmly retained in place on the surface 20: Again the optional protective coating 16 may alternatively be applied after the application of the layered image structure 10 to the surface 20.

An important feature of the layered image structures of the invention in all three embodiments is the ability if required to remove the layered image structure after a period of use (for example, to replace the image with a new image) without significantly damaging the underlying surface 20. The reinforcing substrate layer facilitates the effective removal of the layered image structure by imparting sufficient strength to the structure (or to the residual structure after pre-treatment such as heating prior to removal) such that the structure may generally be removed in one piece. In the first two embodiments of the invention, the application of heat to the layered image structure 10 will cause the material with adhesive properties (adhesive/thermoplastic material) to soften. Ideally, the layered image structure is heated until the layer 18 achieves a temperature of about 60° C. to 80° C. above ambient temperature, in order the achieve the required degree of softening. Heat may be applied by any suitable means such as a heat gun or a steam jet. The use of steam is particularly advantageous since the moisture assists in preventing re-adhesion of the adhesive or thermoplastic material. If necessary, the steam may be heated to approximately 140° C. When the required degree of softening of the layer 18 has been achieved, the reinforcing substrate layer 12 is used to peel the structure 10 away from the surface 20. The reinforcing substrate layer 12 ensures that the layered image structure 10 can normally be peeled away from the surface 20 in a single piece substantially without breaking up, taking with it substantially the entire layer 18 of adhesive material/thermoplastic. The degree of heat required is substantially less than for conventional paint (or thermoplastic) road markings where a temperature of 800° C. to 900° C. is typical and, in this way, substantial damage or residual marking of the surface 20 is avoided. In the second embodiment of the invention, any residual thermoplastic material may be scraped away from the surface or brushed away using a stiff wire brush or nylon type brush while the material is still soft after heating, or may be carefully burnt off.

In the third embodiment of the invention which utilises the curable composition, beat may also be used to remove the layered image structure 10. Generally, sufficient beat may be applied to cause some softening and then crystallisation of the cured composition 18, at which point the adhesive properties of the composition 18 are lost The layered image structure 10 may then be removed utilising the reinforcing substrate layer 12 and any residual cured composition may be removed, such as by sweeping away or cleaning off using a jet wash, steam cleaner, grit blaster or the like, as appropriate to the underlying surface. Desirably, for removal of the layered image structure 10, the cured composition layer 18 is heated to a temperature of from about 100° C. to about 140° C. and the curable composition is selected so that, when cured, it is thermally degradeable at these temperatures. Any suitable means of applying heat may be used such as heat gun or torch, or a long handled roofing torch.

FIG. 2 illustrates a preferred variation of the invention in which a further reticulate or mesh layer is provided. The other parts of the image structure illustrated in FIG. 2 correspond to those of FIG. 1 and hence need not be further described. The further reticulate of mesh layer 22 is disposed between the material with adhesive properties 18 and the surface 20 to which the image structure 10 is applied. In this respect, the spacing of the parts 18, 20, 22 in FIG. 2 is exaggerated. In practice, the further mesh layer 22 will conform to the underside of the layer of material with adhesive properties 18 and to the surface 22 (or to any primer (not shown) on the surface 20). The material of the layer 18 may, and preferably will, penetrate into the mesh of the further mesh layer 22, either by the application of pressure or because the material of the layer 18 may be able to flow to a limited extent, for example after initial heating. In this way, the material of the layer 18 maintains good adhesive contact with the surface 20 but, for example, is constrained by the further mesh layer 22 from flowing or moving in the lateral direction generally parallel to the surface 20.

1-34. (canceled)

35. A layered structure for providing an image on a desired surface, comprising:
a reinforcing substrate layer;
an image applied to an upper surface of the reinforcing substrate layer; and,
a layer comprising a material with adhesive properties for adhering a lower surface of the reinforcing substrate layer to the desired surface.

36. The layered structure according to claim 35, further comprising a mesh layer disposed on a face of the reinforcing substrate layer comprising a material with adhesive properties distal from the reinforcing substrate layer.

37. The layered structure according to claim 35, further comprising a protective transparent coating applied over the image.

38. The layered structure according to claim 37, wherein the protective transparent coating and said material of said layer comprising a material with adhesive properties comprise a substantially similar material, so that the image and said reinforcing substrate layer are encapsulated.

39. The layered structure according to claim 37, wherein the protective transparent coating includes particles of anti-slip aggregates.

40. The layered structure according to claim 37, wherein the protective transparent coating includes a member selected from the group consisting of glass beads, clear silica beads, opalescent sand and a combination thereof.

41. The layered structure according to claim 35, wherein the image is a printed image.

42. The layered structure according to claim 41, wherein the printed image is printed directly onto the reinforcing substrate layer.

43. The layered structure according to claim 41, wherein the printed image is printed onto a substrate and the substrate is applied to the reinforcing substrate layer.

44. The layered structure according to claim 35, wherein the reinforcing substrate layer comprises a mesh material.

45. The layered structure according to claim 35, wherein said layer of material with adhesive properties is an adhesive.

46. The layered structure according to claim 45, wherein said adhesive is a pressure-sensitive adhesive.

47. The layered structure according to claim 35, wherein said layer of material with adhesive properties comprises a bituminous adhesive layer.

48. The layered structure according to claim 47, wherein the bituminous adhesive layer is a glass fiber-reinforced bituminous adhesive layer.

49. The layered structure according to claim 35, wherein said layer of material with adhesive properties comprises a high-track thermoplastic material.

50. The layered structure according to claim 35, wherein said layer of material with adhesive properties comprises a liquid composition curable at a site of application.

51. A method for applying an image structure to a desired surface, comprising the steps of:
providing a layer image structure comprising:
a reinforcing substrate layer;
an image applied to an upper surface of said reinforcing substrate layer; and,
an adhesive layer applied to a lower surface of said reinforcing substrate layer; and,
applying said layer image structure to a desired surface.

52. The method for applying an image structure to a desired surface according to claim 51, further comprising the step of:
heating said adhesive layer prior to said step of applying said layer image structure to the desired surface.

53. The method for applying an image structure to a desired surface according to claim 51, wherein the image comprises a printed image.

54. The method for applying an image structure to a desired surface according to claim 51, wherein said reinforcing substrate layer comprises a mesh material.

55. The method for applying an image structure to a desired surface according to claim 51, further comprising the step of:
applying a protective transparent coating over said image.

56. A method for applying an image structure to a desired surface, comprising the steps of:
(a) providing a layered image structure comprising
a reinforcing substrate layer; and,
an image applied to an upper surface of said reinforcing substrate layer;
(b) applying a layer comprising a material with adhesive properties to a desired surface; and,
(c) applying said layered image structure to said material with adhesive properties.

57. The method for applying an image structure to a desired surface according to claim 56, wherein step (b) further comprises the steps of:
applying a mesh layer to the desired surface; and,
applying said layer comprising a material with adhesive properties over said mesh layer to the desired surface.

58. The method for applying an image structure to a desired surface according to claim 56, wherein said layer comprising a material with adhesive properties comprises a high-track thermoplastic material.

59. The method for applying an image structure to a desired surface according to claim 56, wherein said layer comprising a material with adhesive properties is curable at a site of application.

60. The method for applying an image structure to a desired surface according to claim 56, further comprising the step of curing said material with adhesive properties.

61. The method for applying an image structure to a desired surface according to claim 56, wherein the image comprises a printed image.

62. The method for applying an image structure to a desired surface according to claim 56, wherein said reinforcing substrate layer comprises a mesh material.

63. The method for applying an image structure to a desired surface according to claim 56, further comprising the step of:
applying a protective transparent coating over said image.

64. A system for applying an image to a desired surface, comprising:
a layered image structure comprising:
a reinforcing substrate layer; and,
an image applied to a surface of said reinforcing layer; and,
adhesive material for applying to said reinforcing substrate layer or the desired surface for adhering said reinforcing substrate layer to the desired surface.

65. The system for applying an image to a desired surface according to claim 64, further comprising a mesh layer disposed between said adhesive material and the desired surface.

66. The system for applying an image to a desired surface according to claim 64, wherein said image is a printed image.

67. The system for applying an image to a desired surface according to claim 64, wherein said reinforcing substrate layer comprises a mesh material.

68. The system for applying an image to a desired surface according to claim 64, wherein said layered image structure further includes a protective transparent coating applied to said image.

69. The system for applying an image to a desired surface according to claim 64, wherein said adhesive material is a curable composition.

70. The system for applying an image to a desired surface according to claim 69, wherein said adhesive material is a two-component system and the two components being mixed for initiating curing.
